(19) United States
(12) Patent Application Publication
(10) Pub. No.: US 2018/0310597 A1
(43) Pub. Date: Nov. 1, 2018

(54) NOODLES AND NOODLE DOUGH CONTAINING A MICROALGAL FLOUR

(71) Applicant: Corbion Biotech, Inc, South San Francisco,, CA (US)

(72) Inventors: Goichi Ito, Tokyo (JP); Yoshitaka Okubo, Chiba (JP)

(73) Assignee: Corbion Biotech, Inc., South San Francisco, CA (US)

(21) Appl. No.: 15/574,090

(22) PCT Filed: May 19, 2015
(86) PCT No.: PCT/EP2015/061028

§ 371 Date: Nov. 14, 2017

(51) Int. Cl. A23L 7/109; A23L 17/60

(52) U.S. Cl. CPC A23L 7/109; A23V 2002/00; A23L 17/60

(57) ABSTRACT

The present invention relates to noodle products comprising a high-lipid microalgal flour, and to noodle doughs suitable for preparing such noodle products. More particularly, the noodle dough comprises from 0.05% to 15% w/w of a microalgal flour comprising at least 50% of lipid by dry weight. The resulting noodle products show a reduced cooking time compared to regular noodles free of such microalgal flour.

### FIELD OF THE INVENTION

The present invention relates to noodles with improved properties in term of cooking time and noodle dough suitable for manufacturing such noodles. More particularly, the invention relates to noodles containing in addition to usual ingredients, a microalgal flour. The use of such microalgal flour has great impact on a large variety of noodles, including dry noodles, fresh noodles and frozen noodles.

### BACKGROUND OF THE INVENTION

Noodles, such as instant noodles, pasta or dumpling noodles, are one of the most consumed food worldwide. A large variety of noodles exist, based on wheat or other starch sources like buckwheat, potato, rice, mung bean, etc.

Whatever the kind of noodles, the process basically comprises adding water to a starch source (most often wheat flour) and optional additional ingredients, kneading them together into a noodle dough and shaping them before cooking.

In the kneading, or mixing step, the dry and liquid ingredients are processed into crumbly dough with small and uniform particle sizes. After mixing, the dough are most often rested before compounding. Dough resting helps water to penetrate into dough particles evenly, resulting in a smoother and less streaky dough after sheeting. The rested, crumbly dough pieces are typically passed through at least a pair of sheeting rolls to form a noodle dough sheet. The sheets may be passed through further set of sheeting rolls to form thinner sheets. Noodles slitting is done by a cutting machine. The sheet is cut into noodles strands of desired width with a slitter. Noodles can be either square or round in shape by using various slitters. Noodles strands are cut into a desired length by a cutter. Additional steps may occur, such as drying step (for example air-drying or fry-drying), frozen steps, etc. to prolong their life date. Furthermore, depending of the kind of noodles, some specific steps may be implemented in a specific order. For instance, for making some types instant noodles, the noodles strands are waved before steaming and cutting. Fresh pasta are obtained by subjecting the freshly extruded pasta dough to boiled water and/or steam cooking.

Generally speaking, noodles products in the raw state require about thirty minutes of cooking in water at a rolling boil in order to be edible. A long cooking time may have a negative impact both on the final cost, including production cost, and the texture.

Quick cooking alimentary paste products have been developed that require a cooking time of about 5-15 minutes. For instance, dough comprising a hard wheat flour and a small amount of a proteinaceous material such as soy flour, vital wheat gluten, have been proposed. The dough was further gelatinized by water or steam cooking and dried. However, such products, in addition to having a tendency to form a slimy surface upon being cooked, also possess an undesirable flavor because of the presence of vital gluten or harsh flavored soy materials. Furthermore, the dough could be used solely for preparing dried pasta, excluding fresh and frozen pasta.

Noodles wherein wheat flour has been partially replaced by a microalgal flour have also been developed. However, neither the final taste nor the texture after cooking were pleasant. More particularly, both the swilling index and the water absorption properties were increased, so that even with undercooked noodles, the mouthfeel was distasteful.

Accordingly, a need exists for a solution to reduce the cooking time of all kinds of noodles without detrimental impact for consumers particularly on the texture and palatability.

### SUMMARY OF THE INVENTION

By conducting experiments and research, the inventors have discovered that the addition of a high-lipid microalgal flour to the traditional ingredients of noodles may have a positive impact on their cooking time. More surprisingly, the inventors have discovered that, despite this addition of microalgal flour, neither the rest of the recipe nor the manufacturing process have to be modified to obtain the desired effect on cooking time. The addition of from 1 to 200 g of a high-lipid microalgal flour per kilogramme of wheat flour or other starch components, during the manufacturing process, allows to decrease the total time required for obtaining edible noodles. Furthermore, the great impact on cooking time may be obtained whatever the kind of noodles, including instant noodles, fresh noodles and frozen noodles.

It is therefore an object of the present invention to provide a noodle product comprising from 0.1 to 20 parts of a microalgal flour comprising at least 50% of lipid by dry weight, per 100 parts of powder phase, preferably from 0.5 to 5 parts of microalgal flour.

Depending on the kind of noodles to prepare, the powder phase may preferably comprise wheat flour, rice flour, buckwheat flour, wheat semolina, wheat starch, tapioca starch, maize starch and/or potato starch.

It is another object of the invention to provide a base noodle dough comprising
between 0.05% and 15% w/w of a microalgal flour comprising at least 50% of lipid by dry weight, preferably from 0.5% to 5% w/w, more preferably from 1% to 3% w/w of microalgal flour;
between 50% and 80% w/w of a powder phase; and
between 20% and 30% w/w of water.

The present invention further relates to a process for preparing noodles, wherein from 0.05% to 15% w/w of a microalgal flour comprising at least 50% of lipid by dry weight, preferably from 0.5% to 5% w/w, more preferably from 1% to 3% w/w, are mixed with other dry and liquid ingredients to form a base noodles dough, before to shape the noodles. According to the invention, the shaped noodles may be further steamed and/or fried and/or dried and/or boiled.

It is a further object of the invention to provide a method for decreasing the cooking time of noodles, wherein from 0.05 to 15% w/w of microalgal flour comprising at least 50% of lipid by dry weight are added to the ingredients during the manufacture of the base noodles dough, preferably from 0.5% to 5% w/w, more preferably from 1% to 3% w/w of microalgal flour.

The invention also relates to the use of a microalgal flour comprising at least 50% of lipid by dry weight in a base noodle dough for decreasing the cooking time of noodles. Advantageously, from 1 to 200 g of microalgal flour per kilogram of powder phase are added to the ingredients during the manufacture of the base noodles dough, preferably from 5 to 50 g of a microalgal flour.

### BRIEF DESCRIPTION OF THE DRAWINGS

FIG. 1 shows the texture change of fry type instant noodles measured with a texture analyser (TA) with “Knife type chip”. The measurement consists on putting one noodle string on the stage and cutting it with knife shape chip to measure it's hardness. At the peak point of the curve, the score is set as hardness of the noodle. If a hardness of 0.4 N is set as the limit to eat, the boiling time is reduced of about 8% (195 seconds compared to 180 seconds). The rehydration speed of noodles with Algility HL is faster than that of control noodles;

FIG. 2 shows the texture change of non-fry type instant noodles measured with TA by using “Knife type chip”. If a hardness of 0.2 N is set as the limit to eat, the boiling time is reduced of about 20% (225 seconds compared to 180 seconds). The rehydration speed of noodles with Algility HL is faster than that of control noodles;

FIG. 3 shows the texture change of dry pasta measured with TA by using “Tooth shape chip”. The measurement consists on pushing one noodle string with tooth type chip and measuring stress, and earning stress curve. If a hardness of 0.45 N is set as the limit to eat, the boiling time is reduced of about 32% (420 seconds compared to 280 seconds). The rehydration speed of noodles with Algility HL is faster than that of control noodles;

FIG. 4 shows photos of cross sections of dumpling sheets after various boil times. Un-reconstructed area at the center of cross sections may be seen for control noodles after 8 to 10 minutes boil time, while such unreconstructed areas are not present with algility HL. Control noodles required 11 minutes to be well cooked, while Algility HL noodles required solely 8 minutes, that is to say that the boiling time is reduced of about 27%. The rehydration speed of dumpling sheet with Algility HL is faster than that of control sheets;

FIG. 5 shows the texture change of fresh Udon noodles measured with TA by using “Tooth shape chip”. If a hardness of 0.65 N is set as the limit to eat, the boiling time is reduced of about 40% (5 minutes compared to 3 minutes). The rehydration speed of fresh Udon noodles with Algility HL is faster than that of control Udon noodles;

FIG. 6 shows the texture change of fresh/frozen Udon noodles measured with TA by using “Tooth shape chip”. If a hardness of 0.9 N is set as the limit to eat, the boiling time is reduced of about 20% (5 minutes compared to 4 minutes). The rehydration speed of fresh/frozen Udon noodles with Algility HL is faster than that of control Udon noodles;

FIG. 7 shows the texture change of boiled/frozen Udon noodles measured with TA by using “Tooth shape chip”. If a hardness of 0.60 N is set as the limit to eat, the boiling time is reduced of about 20% (5 minutes compared to 4 minutes). The rehydration speed of boiled/frozen Udon noodles with Algility HL is faster than that of control Udon noodles;

FIG. 8 shows the texture change of fresh pasta measured with TA by using “Tooth shape chip”. If a hardness of 2.6 N is set as the limit to eat, the boiling time is reduced of about 50% (120 seconds compared to 60 seconds). The rehydration speed of fresh pasta with Algility HL is faster than that of control pasta;

FIG. 9 shows photos of cross sections of frozen dumpling sheets after boiling time. An un-cooked area at the center of the cross section of the control may be seen for after 1 minutes and 45 seconds steam boil time that is not present with algility HL;

FIG. 10 shows the texture change of fresh Udon noodles measured with TA by using “Tooth shape chip”. The hardness of 1 minute cooked noodles was set as 1 in each recipe and the hardness ratio was calculated in each cooking time, in order to consider cooking speed solely, by excluding other factor. An effective dosage above 0.1% w/w of Algility HL has been confirmed, and the impact of Algility HL on cooking time has been confirmed;

FIG. 11 shows the oil content of each recipe (control; algility HL; Olive oil noodles);

FIG. 12 shows the effect of Algility HL and Olive oil on both the pressure gelling property and the stretch gelling property. The results confirm that the use of Algility HL by decreasing pressure gelling property solely has a positive impact on noodles elasticity.

### DESCRIPTION OF THE INVENTION

Microalgae are already used in food to improve the nutritional or health benefit of food. Some microalgal biomass with high lipid content are also used in replacement of at least part of lipid in traditional recipes, to reduce the total amount of lipid into the final products. By conducting specific experiments on microalgal biomass, the inventors have discovered that the addition of a microalgal flour comprising at least 50% of lipid by dry weight to the ingredients for noodles or pasta leads to quick-cooking noodles. Surprisingly, the addition of such microalgal flour does not impair the texture or palatability of the product. Furthermore, the decrease of the cooking time does not impact on the property of the product to resist to overcooking. According to the invention, neither the ingredients nor their respective amounts are modified compared to regular noodles. In the same way, the process for manufacturing the noodles remains same, except the additional step of adding the microalgal flour.

The following is a description of the present invention, including preferred embodiments thereof given in general terms. The present invention is further exemplified in the disclosure given under the heading “Examples” herein below, which provides experimental data supporting the invention and means of performing the invention.

### Definitions

The present disclosure will be best understood by reference to the following definitions.

As used herein, the term “about” means within 10%, more preferably within 5%, even more preferably within 1% of a given value or range. Alternatively, “about” means within an acceptable standard error, reflecting tolerances, conversions factors, rounding off, measurement error and the like, and others factors known to those skill in the art.

In the context of the invention, “w/w”, in reference to proportions by weight, means the ratio of the weight of one substance in a composition to the weight of the composition. For example, reference to a composition that comprises 5% w/w microalgal flour means that 5% of the composition's weight is composed of microalgal flour (e.g., such a composition having a weight of 100 mg would contain 5 mg of microalgal flour) and the remainder of the weight of the composition (e.g., 95 mg in the example) is composed of other ingredients. Alternatively, the proportion of one ingredient may be indicated in relation with a reference ingredient, using the number of parts of the reference ingredient as a referential.

“Dry weight” and “dry cell weight” mean weight determined in the relative absence of water. For example, reference to microalgal biomass as comprising a specified percentage of a particular component by dry weight means that the percentage is calculated based on the weight of the biomass after substantially all water has been removed.

The term “ingredient”, as used herein, means edible ingredients usually used in noodles compositions. “Ingredient” includes, without limitation, sources of starch, liquids, such as water and milk, eggs and eggs products, sugar and sugar substitutes, fats, preservatives, flavorants, food additives, food coloring, and other ingredients found in various foods.

The terms “finished noodle/pasta product”, “noodles/pasta” and “noodle/pasta product” are used interchangeably to refer to a noodle/pasta composition that is ready for packaging, use, or consumption. For example, the “noodle/pasta product” may be mixed or otherwise integrated with one another ingredient, and/or at least partially cooked or dried or steamed.

A “base noodle/pasta dough” or “noodle/pasta dough” refers to the mixture obtained by admixing the moist and dry ingredients of the recipe of a noodle/pasta product. The dough is the mix of raw ingredients, before any cooking and/or shaping steps. A noodle dough includes a powder phase, such as wheat flour, and water, and may include other ingredients.

The expression “regular noodles product” is used therein to designate a noodle product deprived of microalgal flour. All the ingredients and amounts for a considered regular noodle product are preferably identical with the ingredients and amounts for the corresponding noodle product of the invention that additionally comprises a quantity of lipid-rich microalgal flour.

In the context of the invention “semolina” refers to coarse flour usually milled from durum wheat. Semolina, especially wheat semolina, is frequently used to make pasta products, while noodles are typically created from wheat flour recipes.

The terms “palatability” and “mouthfeel” are used to refer to the perception of the food composition in the mouth. Palatability/mouthfeel are terms used and understood by those of skill in the art. Palatability/mouthfeel include perceptions selected from the group consisting of the cohesiveness, density, astringency, dryness, fracturability, graininess, gumminess, hardness, heaviness, moisture absorption, moisture release, mouthcoating, roughness, slipperiness, smoothness, uniformity, uniformity of bite, uniformity of chew, viscosity and wetness of the food composition when placed in the mouth.

Microalgae Flour

According to the invention, a microalgal flour is used together with other moist and dry ingredients to prepare noodles or pasta.

For the purpose of the invention, the term “microalgal flour” means a substance comprised of a plurality of particles of microalgal biomass, with an average size of particles preferably comprised from 0.5 to 100 μm, preferably from 1 to 15 μm as measured on a COULTER® LS laser particle size analyser. More precisely, the microalgal flour granules according to the invention may be characterized by their particle mode diameter (D mode). This measurement may be carried out on a COULTER® LS laser particle size analyser, equipped with its small volume dispersion module or SVM (125 ml), according to the specifications provided by the manufacturer (e.g., in the “Small Volume Module Operating instructions”). The microalgal biomass refers to a material produced by growth and/or propagation of microalgal cells and may contain cells and/or intracellular contents as well as extracellular material, such as compounds secreted by a cell. “Microalgae”, or “Microalgal cell”, means a eukarytotic microbial organism that contains a chloroplast, and which may or may not be capable of performing photosynthesis. Microalgae include obligate photoautotrophs, which cannot metabolize a fixed carbon source as energy, as well as heterotrophs, which can live solely off of a fixed carbon source, including obligate heterotrophs, which cannot perform photosynthesis. Generally speaking, “microalgal flour” is not intended to refer to a mixture prepared with basic components such as proteins, lipids and polysaccharides. On the contrary, it refers to a microalgal biomass with its complex composition. Preferably, the microalgal flour contains at least 80% in weight, more preferably at least 90, 95 or 99% by weigh of microalgal biomass.

For the purpose of the invention, a large variety of microalgae may be used, although microalgae that are already known as healthy for human beings are preferred. For instance, digestible microalgae are preferred. Digestibility is generally decreased for microalgal strains which have a high content of cellulose/hemicellulose in the cell walls. Digestibility can be evaluated using standard assays known to the skilled artisan for example, pepsin digestibility assay. Additional properties, such as the ease of growth; the ease of propagation; the ease of biomass processing; the glycerolipid profile; and the absence or near absence of algal toxins, may be considered when choosing the microalgae. The microalgal cells may be either whole, disrupted, or a combination of whole and disrupted cells. Preferably the microalgal flour is prepared from concentrated microalgal biomass that has been lysed and homogenized and optionally dried. Preferably at least 90%, more preferably at least 95%, 96%, 97%, 98%, 99%, 100% of the cells are lysed to release their content that includes oil. Furthermore, the cell wall and intracellular components may be micronized.

Examples of processes for preparing suitable microalgal flours are described in the patent application WO2014/064231 (incorporated therein by reference).

According to the invention, the microalgal flour is lipid-rich. By “lipid-rich” or “high-lipid” flour is intended to refer to a flour comprising at least 50% of lipid by dry weight, preferably at least 75% of lipid by dry weight. The microalgal flour may also provide other benefits, such as micronutrients, dietary fibres (soluble and insoluble carbohydrates), phospholipids, glycoproteins, phytosterols, tocopherols, tocotrienols, and selenium.

For instance, the lipid-rich microalgal flour is composed of 50 to 75% lipid, 1 to 10% protein, and 10 to 30% fiber, with a moisture content of 5% or less. In a particular embodiment, the lipid-rich microalgal flour is composed of about 50% lipid, about 8% protein, about 15% fiber, with a moisture content of about 3%.

For the purposes of the invention, microalgae from the genus Chlorella, because of its high composition of lipid, are preferred. In a particular embodiment, the microalgal flour is produced from the dried biomass of Chlorella, preferably from the dried biomass of Chlorella protothecoides.

Noodle Dough and Noodles

According to the invention, a defined amount of high-lipid microalgal flour is added to the ingredients traditionally used to prepare a base noodle dough that will be further processed to make noodles or pasta.

The usual ingredients of a noodle dough include at least a powder phase and a liquid, most often water.

The powder phase consists preferably of at least one source of starch. Advantageously, such powder phase comprises at least one of the ingredients selected from wheat flour, rice flour, buckwheat flour, wheat semolina, wheat starch, maize starch, tapioca starch, and potato starch.

A noodle dough may be made from one or more source of starch. In a particular embodiment, a noodle dough comprises both wheat flour and potato starch. In another embodiment, the noodle dough comprises wheat flour and wheat semolina.

In a preferred embodiment, the noodle dough is based on wheat that is to mean that more than 50% by dry weight of the powder phase, preferably more than 75%, even more preferably more than 85%, is obtained from wheat. That is to say that 100 parts of the source of starch in the final noodle product are preferably composed of more than 50 parts, preferably more than 75 parts, even more preferably more than 85 parts of a wheat starch.

In a particular embodiment, the source of starch that composes the base noodle dough comprises from 75% to 95% by weight of wheat flour and from 5% to 25% by weight of potato starch. For instance, the sources of starch comprises from 75% to 90% by weight of wheat flour and from 10% to 25% by weight of potato starch. In another example, the sources of starch comprises from 85% to 95% by weight of wheat flour and from 5% to 15% by weight of potato starch.

In another embodiment, the source of starch that composes the base noodle dough comprises between 40% and 60% by weight of wheat flour and between 40% and 60% by weight of wheat semolina, preferably about 50% by weight of wheat flour and about 50% by weight of wheat semolina. That is to say that 100 parts of the source of starch in the final noodle product comprise from 40 to 60 parts of wheat flour and from 40 to 60 parts of wheat semolina, preferably about 50 parts of wheat flour and about 50 parts of wheat semolina.

In a particular embodiment, the sources of starch may comprise solely wheat flour or wheat semolina.

Depending on the amount of the powder phase and the kind of noodles intended, the amount of microalgal flour may be from 0.05% to 15% w/w, preferably from 0.5% to 5% w/w, more preferably from 1% to 3% w/w. Advantageously, the amount of microalgal flour is determined based on the amount of the powder phase used to prepare the dough. Advantageously, from 0.1 to 20 parts of a microalgal flour, preferably from 1 to 10 parts, more preferably from 2 to 5 parts of a microalgal flour are added to 100 parts of powder phase, such as wheat flour, potato starch, semolina, etc.

Additionally, the base dough noodles comprises from 20% to 30% w/w of a liquid, preferably water. The liquid may also comprise a vegetable juice such as carrot or spinach juice.

The base noodle dough may also comprises additional dry and moist ingredients. For instance, the dough may comprise egg or egg product, including whole eggs or white eggs, salt, food additives, such as alkaline agent, vitamins, gluten supply, etc.

In a particular embodiment, the base dough noodles comprises from 2% to 4% w/w of egg or egg products. And the final noodle product will comprise from about 3 to 5 parts of egg or egg products for 100 parts of powder phase.

Furthermore, the noodle product may comprise from 0 to 10, preferably from 0.2 to 5 parts of salt, and/or from 0.2 to 1 part of at least one food additive, preferably selected from alkaline agent, vitamins, gluten supply, and/or from 2 to 6 parts of egg or egg product. In a particular embodiment, the alkaline agent comprises potassium carbonate, sodium carbonate, sodium hydrogen carbonate, and optionally some phosphate. Alkaline agents are useful to change the dough pH and to make the gluten network tightly and the noodles texture stronger.

The microalgal flour is particularly useful for reducing the cooking-time of instant noodles. Instant-noodles are precooked and dried alimentary paste which, when immersed in boiling water, rehydrates within minutes to form edible products that can be used in soups and stews, or as side dishes or snacks. These instant-noodles are typically purchased as a dried brick of noodles with spice packets that provide a desirable flavor and appearance to the resulting foodstuff.

In a particular embodiment, the base noodle dough is dedicated to non-fry instant noodles, and comprises
between 70% and 75% w/w wheat flour;
between 20% and 30% w/w of water;
between 1% and 2% w/w of algal flour and optionally
between 1% and 2% w/w of salt, and/or between 0.2% and 0.4% of an alkaline agent.

In another embodiment, the base noodle dough is dedicated to dry pasta, and comprises
between 70% and 80% w/w wheat semolina; and
between 2.5% and 3.5% w/w of algal flour.

In a further embodiment, the base noodle dough is dedicated to fry instant noodles, and comprises
between 60% and 70% w/w wheat flour;
between 6% and 10% w/w of potato starch;
between 20% and 30% w/w of water;
between 2% and 3% w/w of algal flour; and optionally
about 1% w/w of salt, and/or between 0.3% and 0.5% an alkaline agent, and/or between 0.01% and 0.03% of vitamin E.

The microalgal flour may also be used to prepare Japanese wheat noodle, also called “udon”. Udon are wheat based noodles make in thick strips that may be eaten cold or hot, generally in soup or broth depending on the dishes.

Accordingly, in a particular embodiment, the base noodle dough is dedicated to udon and comprises
between 55% and 60% w/w of wheat flour;
between 8% and 12% w/w of potato starch;
between 20% and 30% w/w of water;
between 1% and 2% w/w of algal flour; and optionally
between 2% and 3% w/w of salt.

The microalgal flour may also be used to prepare fresh pasta. The term “fresh pasta” designates a pasta product containing eggs or egg product that cooks in a shorter time than conventional dry pasta. In another particular embodiment, the base noodle dough is dedicated to fresh pasta, and comprises
between 35% and 40% w/w of wheat flour;
between 35% and 40% w/w of wheat semolina;
between 3% and 5% w/w of eggs;
between 20% and 30% w/w of water;
between 1.5% and 2.5% w/w of algal flour; and optionally
between 0.2% and 0.5% w/w of salt.

Dumplings are a food that consists of small pieces of dough, They can be based on flour, potatoes or bread, and may include meat, fish, vegetables, or sweets. Dumplings may be sweet or savory.

In the same way, the addition of microalgal flour to the ingredients of dumpling dough leads to the production of quick-cooked dumpling. Dumpling refers to small pieces of dough, either cooked alone, such as gnocchi, or wrapped around a filling, such as wontons or ravioli. They may be cooked by boiling, steaming, simmering, frying, or baking. They may have a filling, or there may be other ingredients mixed into the dough. They can be eaten by themselves, in soups or stews, with gravy, or in any other way.

Thus, in another embodiment, the base noodle dough is dedicated to dumpling, and comprises
between 70% and 80% w/w wheat flour;
between 20% and 30% w/w of water;
between 1.5% and 2.5% w/w of algal flour; and optionally
between 0.5% and 1% w/w of salt and/or between 0.3% and 0.5% of an alkaline agent.

Process for Manufacturing Noodles

It is another object of the invention to provide a process for manufacturing rapid-cooking noodles or pasta. According to the invention, from 0.05% and 15% w/w of a lipid-rich microalgal flour are mixed with other dry and liquid or moist ingredients to form a base noodles dough, before to shape the noodles.

The presence of the microalgal flour allows to decrease to up to 30% or more the cooking time, compared to regular noodles or pasta containing the same ingredients, in the same amounts, except microalgal flour. Interestingly, one may notice that the resistance to overcooking is not changed. That is to say that the noodles of the invention, when overcooked, have the same texture as regular noodles.

The decrease of the cooking time may have an economic impact on both the manufacturer and the consumer. More particularly, the steam time required for pre-cooked products but also the final cooking time required just before eating may be reduced.

According to the invention, the process comprises the step of adding from about 0.1 to 20 parts, preferably from 1 to 10 parts, more preferably from 2 to 5 parts of a microalgal flour to the ingredients of the noodle dough for 100 parts of powder phase, such as wheat flour, potato starch, semolina, etc.

In a particular embodiment, the microalgal flour is mixed with the dry ingredients (i.e. powder phase, salt, etc.) and moist ingredients (i.e. liquid, eggs and egg product, etc.) to obtain the desired consistency.

In a particular embodiment, the dough is then sheeted onto a surface as a layer of dough. The sheeted dough is preferably worked by passing through a series of reduction rollers to obtain the desired thickness. Advantageously, the thickness of the rolled dough is between about 0.5 mm to about 4 mm, preferably between about 0.5 mm and 2.0 mm, and more preferably between about 1 mm and about 1.7 mm. Alternatively, the dough is extruded by using a die of diameter from about 1 mm to about 2 mm. After the dough has been sheeted, it may be shaped, for example by slicing the dough into long ribbons using, for example, a slitter that cuts 20 strands per 3 cm.

A step of precooking may be implemented. For instance, the precooking step is performed in a heated fluid such as, boiling water or steam at between about 80° C. to about 120° C., preferably at between about 90° C. to about 110° C., and more preferably at between about 100° C. to about 105° C. Precooking times vary between about 30 seconds to about 15 minutes, preferably less than 10 minutes and more preferably less than 5 minutes, and even more preferably between about 1 minute to about 3 minutes.

The ribbons noodles are preferably cut to predetermined lengths using, for example, a fly knife cutter. Shorter noodles are generally preferred for soups and long noodles as a main course meal. Noodles can be cut to nearly any length from short pieces to long strands. Ramen noodles are of moderate length, between about 1.0 cm to about 100 cm, preferably between about 20 cm to about 60 cm and more preferably between about 15 cm to 25 cm.

A drying step may also be performed, for example using high temperatures in the presence of hot air moving across or through noodles surfaces at high velocities. Preferably, air flow is directed at and through the noodles. When used in drying noodles, the air may be supplemented with other components such as compounds which assist in the absorption of water. Other gasses or mixtures thereof which do not affect the properties or edibility of the final product may also be employed in place of the air. Drying temperatures are above 70° C., preferably above 80° C., and more preferably between 85° C. and 95° C. Increased temperatures shorten drying times. For example, typical drying times for temperatures between about 85° C. to about 95° C. are less than about 1 hour.

This procedure can also be used for shorter periods of time, such as half the stated periods, when moisture content does not need to be reduced as low. These types of noodles are dried, albeit to a reduced degree, and quick frozen or refrigerated. Noodles that are to be stored refrigerated or frozen have a moisture content of between about 20% to about 35% or higher. Storage times are not decreased because the noodles products are maintained refrigerated or frozen.

The manufacturing techniques used for these types of noodles easily lend themselves to automation. The dough can be prepared in bulk, sheeted onto moving surfaces, sliced, cut and steamed all along an assembly line. The dough can be rolled, sliced and steamed as it travels along a conveyor. As the drying step is performed in a relatively short time, ovens can be included in the assembly line without slowing the conveyor or overall manufacturing process.

The final noodle product according to the invention comprises from 0.1 to 20 parts of a lipid-rich microalgal flour per 100 parts of flour, preferably from 1 to 10 parts, more preferably from 1 to 5 parts, and exhibits a decreased cooking time compared to regular noodles product. Advantageously, the cooking time decreases to up to 30% or more.

Accordingly, the invention provides a method for decreasing the cooking time of noodles, wherein between 0.05 and 15% w/w of a high-lipid microalgal flour are added to ingredients to form a base noodles dough, before to shape the noodles.

Other characteristic features and advantages of the invention will be apparent on reading the following Examples. However, they are given here only as an illustration and are not limiting.

### EXAMPLES

In the following examples, different recipes of noodles and pasta have been implemented, wherein an additional amount of high-lipid microalgal flour has been added, in order to evaluate its impact on the cooking time.

For all the recipes of noodles and pasta, the high-lipid microalgal flour Algility HL™ composed of Chlorella protothecoides (commercialized by Roquette) has been used.

In some recipes, the potato starch Clearam PG06™ (also commercialized by Roquette) has been used.

As used therein, “CTR” refers to control noodles and “Algility HL” refers to noodles incorporating such microalgal flour.

### Example 1: Dry Type Noodles

Recipes & Processes

A] Fry Type Instant Noodle

TABLE 1
Fry type instant noodles ingredients

| Ingredient | CTR | algility HL |
|---|---|---|
| Flour (Protein: 11.2%, Ash 0.34%) | 900 | 900 |
| CLEARAM PG06 | 100 | 100 |
| Sub total | 1000 | 1000 |
| algility HL | 0 | 30 |
| Salt | 15 | 15 |
| Kansui (K2CO3 60% Na2CO3 40%) | 5 | 5 |
| Vitamin E | 0.4 | 0.4 |
| Water [Deionized water] | 370 | 370 |
| Total | 1390.4 | 1420.4 |

The fry type instant noodles has been manufactured according to the following successive step:
Mix powder and liquid 12 min 86 rpm;
Compose as 8 mm gap for 3 times;
Roll as below condition to make noodles sheet: 6.5 mm→4 mm→3 mm→2 mm→1.3 mm
Cut 1.5 mm wide with Blade No, 20
Put 80 g separated noodles into a colander and steam for 3 min 15 sec.
Pack the noodles to a mould and deep fry for 1 min 35 sec at 145 C.

B] Non Fry Type Instant Noodle

TABLE 2
Non fry type instant noodles ingredients

| Ingredient | CTR | algility HL |
|---|---|---|
| Flour (Protein: 11.2%, Ash 0.34%) | 900 | 900 |
| CLEARAM PG06 | 100 | 100 |
| Sub total | 1000 | 1000 |
| algility HL | 0 | 30 |
| Salt | 15 | 15 |
| Kansui (K2CO3 60% Na2CO3 40%) | 5 | 5 |
| Vitamin E | 0.4 | 0.4 |
| Water [Deionized water] | 370 | 370 |
| Total | 1390.4 | 1420.4 |

Dipping solution

| Ingredients | Volume |
|---|---|
| Salt | 50 |
| water | 950 |
| Total | 1000 |

The non-fry type instant noodles has been manufactured according to the following successive step:
Mix powder and liquid 3 min 86 rpm and 12 min 46 rpm
Compose as 8 mm gap for 3 times.
Roll as below condition to make noodles sheet:
6.5 mm→4 mm→3 mm→2 mm→1.3 mm→1.25 mm
Cut 1.5 mm wide with Blade No, 20
Put 90 g separated noodles into a colander and steam for 3 min.
After steaming, dip the noodles in dipping solution 75 C for 30 sec.
Pack noodles in to the mould and air dry with oven for 50 min at 90 C.
Cool down under cold wind

C] Dry Pasta

TABLE 3
Dry pasta ingredients

| Ingredient | CTR | algility HL |
|---|---|---|
| Durum semolina | 1000 | 1000 |
| Sub total | 1000 | 1000 |
| algility HL | 0 | 30 |
| Water | 280 | 280 |
| Total | 1280 | 1310 |

The dry pasta has been manufacturing according to the following successive step:
Mix powder and liquid 3 min 90 rpm in ordinary pressure and make dough.
Mix 9 min 90 rpm under vacuum pressure, about −90 kPa
Extrude dough by using φ1.4 mm die. Extruder screw: 50 rpm
Hang the noodles strings, and steam at 98 C for 5 min.
Dry the noodles in thermostatic and humidistatic apparatus. (1^{st} Dry condition: Temperature 85 C, Humidity 75% 3 hr. 2^{nd} Dry condition: Temperature 25 C, Humidity 75% 12 hr)

D] Dry Type Dumpling Sheet

TABLE 4
Dry type dumpling sheet ingredients

| Ingredient | CTR | algility HL |
|---|---|---|
| Flour (Protein: 11.2%, Ash 0.34%) | 800 | 800 |
| Sub total | 800 | 800 |
| algility HL | 0 | 24 |
| Salt | 4 | 4 |
| Kansui (K2CO3 60% Na2CO3 40%) | 4 | 4 |
| Water | 276 | 276 |
| Total | 1084 | 1108 |

The dry pasta has been manufacturing according to the following successive step:
Mix powder and liquid 3 min 86 rpm and 12 min 46 rpm
Compose as 8 mm gap for 3 times
Roll as below condition to make noodles sheet:
6.5 mm→4 mm→3 mm→2 mm→1.3 mm→1.25 mm→0.75 mm
Cut noodles sheet and make 10 cm×10 cm square dumpling sheets and apply water to blue zone above, and fold in double.
Cut the double dumpling sheet 1.5 cm wide
Boil at 98 C for 1 min. and after that remove water by using of basket.
air dry with oven for 90 min at 90 C.

Analyses

In order to evaluate the cooking time and the texture of the cooked noodles, the following steps have been implemented

1. Put noodles in a cup, and pour 500 ml of boiled water.

2. Wait from 2 to 12 minutes, depend on conditions which have to be measured.

3. Measure the TA using the texture analyser Shimadzu EZ-SX, according to the following sequence:

a—Put a string of noodle on stage

b—Start the analyse sequence (Automatic analyse sequence)

c—The plunger starts to drop slowly.

4—When the plunger touches to noodle string, the analyse machine starts to record the force loaded on plunger.

d—The plunger continues to drop until it reaches the stage.

e—The Analyse machine stops the record.

The plunger drop speed is changed by test method (This time: 3 mm/min); The plunger shape is changed by test method (This time: Tooth shape or Knife type). Knife type has dull top, so the data from knife type plunger contain not only noodle hardness, but also noodle elasticity. And the Tooth shape plunger is sharper than Knife type plunger, so that it can describe noodle hardness more than Knife type.
Condition: Time: 1 Plunger: Tooth shape chip

Knife type chip [Depend on application]
Speed: 3 mm/min Sample size: 1 string

4. Compare stress strength at peak point of TA curve.

When required or useful, a cross section photo has been analyzed.

Results

A] Fry Type Instant Noodle

The texture change of fry type instant noodles has been measured with TA, by using “Knife type chip”.

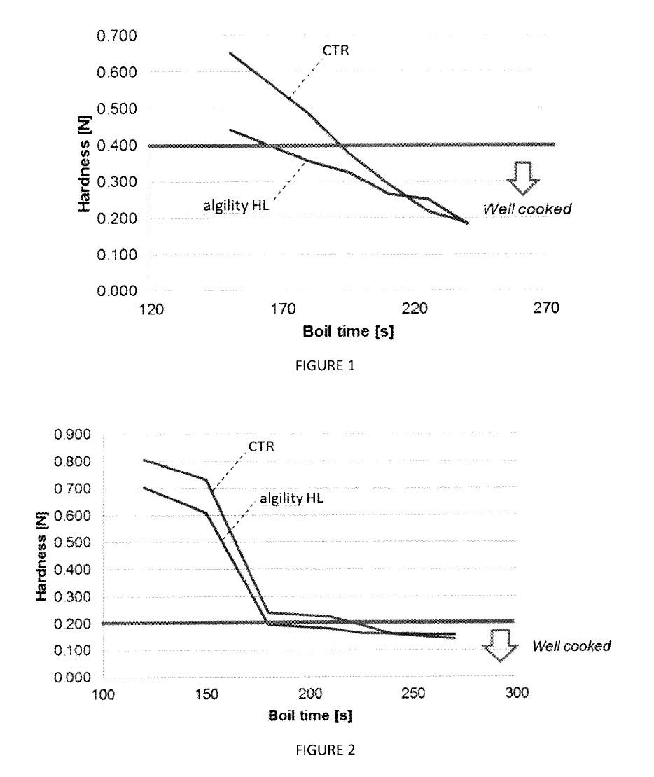

As well noted in the table 5 below and FIG. 1, the rehydration speed of noodles which contain Algility HL is faster than that of control (or regular) noodle: the boiling time is reduced up to 8%.

TABLE 5
Rehydration speed of fry type instant noodles

CTR

| | |
|---|---|
| Time | algility HL |

| [s] | Hardness [N] | Time [s] | Hardness [N] |
|---|---|---|---|
| 150 | 0.652 | 150 | 0.441 |
| 180 | 0.483 | 180 | 0.353 |
| 195 | 0.374 | 195 | 0.323 |
| 210 | 0.291 | 210 | 0.265 |
| 225 | 0.217 | 225 | 0.250 |
| 240 | 0.186 | 240 | 0.182 |

TABLE 6
Mouthfeel of fry type instant noodles

| | Boil time | | | | |
|---|---|---|---|---|---|
| | 2 min | 2.25 min | 2.5 min | 2.75 min | 3 min |
| CTR | Raw | Raw | Raw | Well cooked | Well cooked |
| algility | Raw | Well cooked | Well cooked | Well cooked | Well cooked |
| HL | | | | | |

B] Non-Fry Type Instant Noodle

The texture change of non-fry type instant noodles has been measured with TA, by using “Knife type chip”.

As well noted in table 7 below and FIG. 2, the rehydration speed of noodles which contain Algility HL is faster than that of control noodle: the boiling time is reduced up to 20%.

TABLE 7
Rehydration speed of non-fry type instant noodles

| | |
|---|---|
| CTR | algility HL |

| Time [s] | Hardness [N] | Time [s] | Hardness [N] |
|---|---|---|---|
| 120 | 0.806 | 120 | 0.702 |
| 150 | 0.732 | 150 | 0.608 |
| 180 | 0.239 | 180 | 0.194 |
| 210 | 0.224 | 195 | 0.187 |
| 225 | 0.193 | 210 | 0.181 |
| 240 | 0.159 | 225 | 0.162 |
| 270 | 0.141 | 270 | 0.157 |

TABLE 8
Mouthfeel of non-fry type instant noodles

| | Boil time | | | | | |
|---|---|---|---|---|---|---|
| | 2.75 min | 3 min | 3.25 min | 3.5 min | 3.75 min | 4 min |
| CTR | Raw | Raw | Raw | Raw | Well cooked | Well cooked |
| algility HL | Raw | Well cooked | Well cooked | Well cooked | Well cooked | Well cooked |

C] Dry Pasta

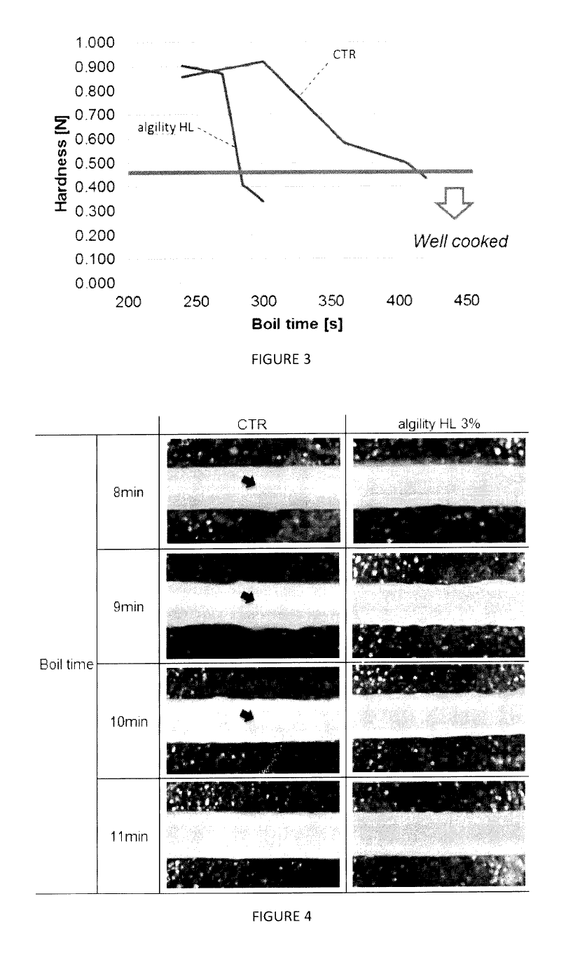

The texture change of dry pasta has been measured with TA, by using “Tooth shape chip”. As well noted in table 9 below and FIG. 3, the rehydration speed of noodles which contain Algility HL is faster than that of CTR noodle: the boiling time is reduced up to 32%.

TABLE 9
Rehydration speed of dry pasta

| | |
|---|---|
| CTR | algility HL |

| Time [s] | Hardness [N] | Time [s] | Hardness [N] |
|---|---|---|---|
| 240 | 0.859 | 240 | 0.906 |
| 300 | 0.922 | 270 | 0.869 |
| 360 | 0.578 | 285 | 0.410 |
| 390 | 0.526 | 300 | 0.339 |
| 405 | 0.501 | | |
| 420 | 0.436 | | |

TABLE 10
Mouthfeel of dry pasta

| | Boil time | | | | |
|---|---|---|---|---|---|
| | 3 min | 4 min | 5 min | 6 min | 7 min |
| CTR | Raw | Raw | Raw | Raw | Well cooked |
| algility HL | Raw | Raw | Well cooked | Well cooked | Well cooked |

D] Dry Dumpling Sheet

The rehydration property of dry dumpling sheet have been compared by cross section photo (see FIG. 4, wherein the black arrow indicates white un-reconstruct area at the center of cross section). The photos confirmed that rehydration speed of dumpling sheet which contain Algility HL is faster than that of control (CTR) sheet. To be well cooked, the control required 11 minutes boiling time, while the noodles of the invention required solely 8 minutes. The cooking time is reduced up to 27%.

Conclusion

The addition of about 2% to about 3% w/w of Algility HL to instant noodles leads to a reduction of the cooking time from about 8% to about 32%. The greatest result is obtained for dry pasta for which the cooking time is reduced up to 32%.

### Example 2: Fresh and Frozen Noodles

Recipes and Processes

A] Fresh/Frozen/Boiled Udon

TABLE 11
Ingredients for udon noodles

| Ingredient | CTR | algility HL |
|---|---|---|
| Flour (Protein: 11.2%, Ash 0.34%) | 850 | 850 |
| CLEARAM PG06 | 150 | 150 |
| Sub total | 1000 | 1000 |
| algility HL | 0 | 20 |
| Salt | 40 | 40 |
| Water | 400 | 400 |
| Total | 1440 | 1460 |

The fresh udon noodles has been manufacturing according to the following successive step:
Mix powder and liquid 12 min 86 rpm.
Compose as 8 mm gap for 3 times
Roll as below condition to make noodles sheet: 6.5 mm→4 mm→3 mm→2 mm→1.7 mm.

Cut 2 mm wide with blade No16.

The frozen udon noodles has been manufacturing according to the following successive step:
Mix powder and liquid 3 min 86 rpm and 12 min 46 rpm
Compose as 8 mm gap for 3 times
Roll as below condition to make noodles sheet: 6.5 mm→4 mm→3 mm→2 mm→1.7 mm. Cut 2 mm wide with blade No, 16.
Put 90 g separated noodles into a colander and quick freeze for 1 hr at −38 C

The boiled and frozen udon noodles has been manufacturing according to the following successive step:
Mix powder and liquid 3 min 86 rpm and 12 min 46 rpm
Compose as 8 mm gap for 3 times
Roll as below condition to make noodles sheet: 6.5 mm→4 mm→3 mm→2 mm→1.7 mm. Cut 2 mm wide with blade No, 16
Boil the noodles in boiled water for 1 min
Cool down the boiled noodles quickly by using ice water
Put 90 g separated noodles into a colander and quick freeze for 1 hr at −38 C.

B] Fresh Pasta

TABLE 12
Ingredients for fresh pasta

| Ingredient | CTR | algility HL |
|---|---|---|
| Durum semolina | 500 | 500 |
| Flour (Protein: 11.2%, Ash 0.34%) | 500 | 500 |
| Sub total | 1000 | 1000 |
| algility HL | 0 | 30 |
| Whole Egg | 50 | 50 |
| Salt | 3.5 | 3.5 |
| Water | 300 | 300 |
| Total | 1353.5 | 1383.5 |

The fresh pasta has been manufacturing according to the following successive step:
Mix powder and liquid 3 min 86 rpm and 12 min 46 rpm
Compose as 8 mm gap for 3 times
Roll as below condition to make noodles sheet: 6.5 mm→4 mm.
Continue to roll as below condition: 2 mm→1.75 mm→1.5 mm. Cut 6.5 mm wide Blade.

C] Fresh/Frozen Dumpling Sheet

TABLE 13
Ingredient for dumpling

| Ingredient | CTR | algility HL |
|---|---|---|
| Flour (Protein: 11.2%, Ash 0.34%) | 1000 | 1000 |
| Sub total | 1000 | 1000 |
| algility HL | 0 | 30 |
| Salt | 10 | 10 |
| Water | 345 | 345 |
| Total | 1355 | 1385 |

The fresh dumpling sheet has been manufacturing according to the following successive step:
Mix powder and liquid 3 min 86 rpm and 12 min 46 rpm
Compose as 8 mm gap for 3 times.
Roll as below condition to make noodles sheet:
6.5 mm→4 mm→3 mm→2 mm→1.3 mm→1.25 mm→0.75 mm
Cut noodles sheet and make φ10 cm circle dumpling sheets
Put meat ingredient inside of this dumpling sheet, and form as dumpling shape

The frozen dumpling sheet has been manufacturing according to the following successive step:
Mix powder and liquid 3 min 86 rpm and 12 min 46 rpm
Compose as 8 mm gap for 3 times
Roll as below condition to make noodles sheet:
6.5 mm→4 mm→3 mm→2 mm→1.3 mm→1.25 mm→0.75 mm
Cut noodles sheet and make φ10 Cm circle dumpling sheets
Put meat ingredient inside of this dumpling sheet, and form as dumpling sheet
Quick freeze for 1 hr at −38 C

Analyses

In order to evaluate the cooking time and the texture of the cooked noodles, the following steps have been implemented

1. Put noodles in a cup, and pour 500 ml of boiled water. 2. Wait a few minutes, depend on conditions which have to be measured. 3. Measure the TA of Shimadzu EZ-SX (see example 1; Plunger drop speed is changed by test method. This time, 3 mm/min; and Plunger shape is changed by test method, This time, Tooth shape)
Condition: Time: 1 Plunger: Tooth shape chip
   Knife type chip [Depend on application]
Speed: 3 mm/min Sample size: 1 string

4. Compare stress strength at peak point of TA curve.

For dumpling, specific steps of cooking and further cross section photos have been made:
1. Add 5 g of oil to pre-heated pan.
2. Put dumplings on the pre-heated pan.
3. Add boiled water 40 ml.
4. Cover the pan with lid, and steam 1 min45 sec.
5. Remove the lid and add 2 g of oil
6. All water was disappear, cooking complete. 7. Cut the dumpling and take photo by using stereoscopic microscope.

Results

A] Udon Noodle

The texture change of fresh udon noodles has been measured with TA, by using “Tooth shape chip”.

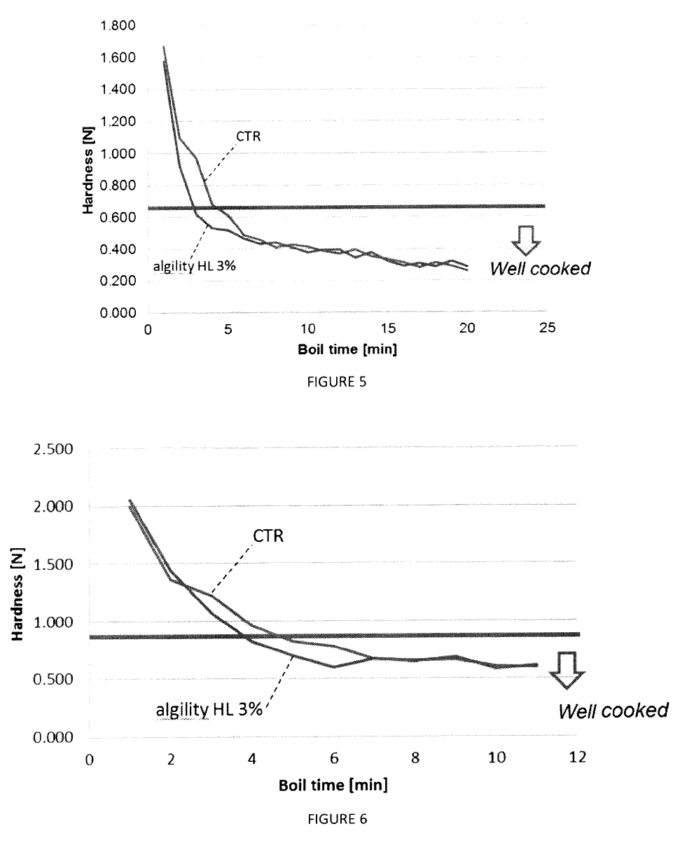

As well noted in the table 14 below and FIG. 5, the rehydration speed of noodles which contain Algility HL is faster than that of control (or regular) noodle: the boiling time is reduced up to 40%.

TABLE 14
Rehydration speed of Udon noodle

Noodle hardness [N]

| Boil time [min] | CTR | algility HL 3% |
|---|---|---|
| 1 | 1.669 | 1.576 |
| 2 | 1.098 | 0.921 |
| 3 | 0.973 | 0.622 |
| 4 | 0.681 | 0.530 |
| 5 | 0.610 | 0.517 |
| 6 | 0.488 | 0.466 |
| 7 | 0.457 | 0.431 |
| 8 | 0.412 | 0.440 |
| 9 | 0.429 | 0.410 |
| 10 | 0.413 | 0.377 |
| 11 | 0.383 | 0.392 |
| 12 | 0.366 | 0.395 |
| 13 | 0.395 | 0.344 |
| 14 | 0.350 | 0.375 |
| 15 | 0.332 | 0.320 |
| 16 | 0.312 | 0.291 |
| 17 | 0.282 | 0.308 |
| 18 | 0.312 | 0.286 |
| 19 | 0.290 | 0.320 |
| 20 | 0.259 | 0.288 |

TABLE 15
Mouthfeel of Udon noodle

| | Boil time | | | | | | | | | |
|---|---|---|---|---|---|---|---|---|---|---|
| | 1 min | 2 min | 3 min | 4 min | 5 min | 6 min | 7 min | 8 min | 9 min | 10 min |
| CTR | Raw | Raw | Raw | Well cooked | Well cooked | Well cooked | Well cooked | Well cooked | Well cooked | Well cooked |
| algility HL | Raw | Raw | Well cooked | Well cooked | Well cooked | Well cooked | Well cooked | Well cooked | Well cooked | Well cooked |

| | 11 min | 12 min | 13 min | 14 min | 15 min | 16 min | 17 min | 18 min | 19 min | 20 min |
|---|---|---|---|---|---|---|---|---|---|---|
| CTR | Well cooked | Well cooked | Over cook | Over cook | Over cook | Over cook | Over cook | Over cook | Over cook | Over cook |
| algility HL | Well cooked | Over cook | Over cook | Over cook | Over cook | Over cook | Over cook | Over cook | Over cook | Over cook |

The texture change of “Fresh/Frozen UDON noodle” has also been measured with TA, by using “Tooth shape chip”.

As well noted in the table 16 below and FIG. 6, the rehydration speed of noodles which contain Algility HL is faster than that of control (or regular) noodle: the boiling time is reduced up to 20%.

TABLE 16
Rehydration speed for Fresh/Frozen Udon noodle

| | |
|---|---|
| Time | Hardness [N] |

| [min] | CTR | algility HL 3% |
|---|---|---|
| 1 | 1.993 | 2.050 |
| 2 | 1.363 | 1.441 |
| 3 | 1.220 | 1.068 |
| 4 | 0.963 | 0.824 |
| 5 | 0.823 | 0.701 |
| 6 | 0.775 | 0.596 |
| 7 | 0.669 | 0.669 |
| 8 | 0.658 | 0.646 |
| 9 | 0.664 | 0.681 |
| 10 | 0.607 | 0.584 |
| 11 | 0.597 | 0.613 |

TABLE 17
Mouthfeel for Fresh/Frozen Udon noodle

| | Boil time | | | | | | | | | |
|---|---|---|---|---|---|---|---|---|---|---|
| | 1 min | 2 min | 3 min | 4 min | 5 min | 6 min | 7 min | 8 min | 9 min | 10 min |
| CTR | Raw | Raw | Raw | Well cooked | Well cooked | Well cooked | Over cook | Over cook | Over cook | Over cook |
| algility HL | Raw | Raw | Well cooked | Well cooked | Well cooked | Well cooked | Well cooked | Over cook | Over cook | Over cook |

The texture change of “Boiled/Frozen Udon noodle” has also been measured with TA, by using “Tooth shape chip”.

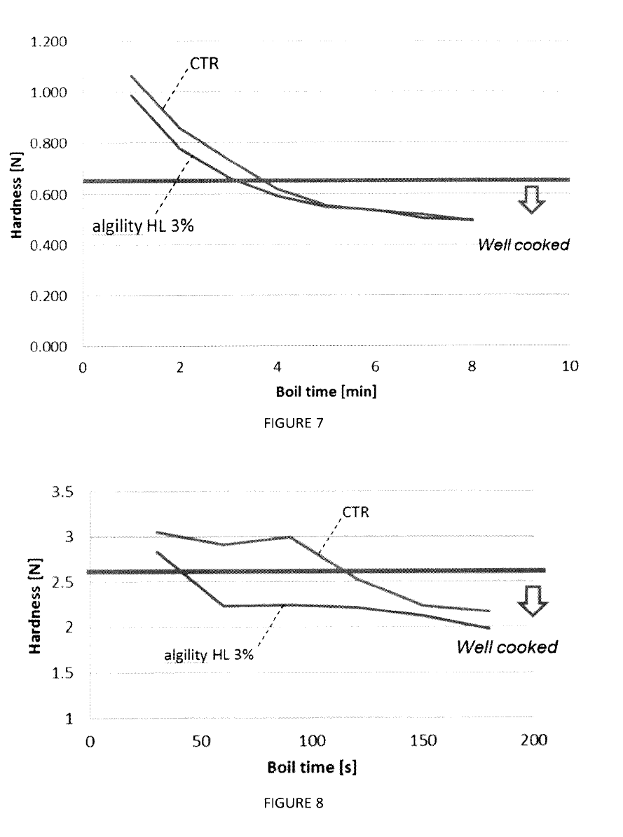

As well noted in the table 18 below and FIG. 7, the rehydration speed of noodles which contain Algility HL is faster than that of control (or regular) noodle: the boiling time is reduced up to 20%.

TABLE 18
Rehydration speed for Boiled/Frozen Udon noodle

| | |
|---|---|
| Time | Hardness [N] |

| [min] | CTR | algility HL 3% |
|---|---|---|
| 1 | 1.063 | 0.988 |
| 2 | 0.859 | 0.780 |
| 3 | 0.737 | 0.666 |
| 4 | 0.618 | 0.590 |
| 5 | 0.555 | 0.547 |
| 6 | 0.532 | 0.536 |
| 7 | 0.517 | 0.504 |
| 8 | 0.494 | 0.497 |
| 9 | 0.478 | 0.410 |
| 10 | 0.458 | 0.427 |

TABLE 19
Mouthfeel for Boiled/Frozen Udon noodle

| | Boil time | | | | | |
|---|---|---|---|---|---|---|
| | 1 min | 2 min | 3 min | 4 min | 5 min | 6 min |
| CTR | Raw | Raw | Well cooked | Well cooked | Well cooked | Well cooked |
| algility HL | Raw | Well cooked | Well cooked | Well cooked | Well cooked | Well cooked |

B] Fresh Pasta

The texture change of “Fresh pasta” has been measured with TA, by using “Tooth shape chip”. As well noted in the table 20 below and FIG. 8, the cooking speed of noodles which contain Algility HL is faster than that of control (or regular) noodle: the boiling time is reduced up to 50%.

TABLE 20
Rehydration speed for fresh pasta

| | CTR | algility HL 3% |
|---|---|---|
| Time[s] | Hardness [N] | Hardness [N] |
| 30 | 3.05 | 2.83 |
| 60 | 2.90 | 2.23 |
| 90 | 2.99 | 2.25 |
| 120 | 2.52 | 2.22 |
| 150 | 2.23 | 2.12 |
| 180 | 2.17 | 1.98 |

TABLE 21
Mouthfeel for fresh pasta

| | Boil time | | | | | |
|---|---|---|---|---|---|---|
| | 30 s | 60 s | 90 s | 120 s | 150 s | 180 s |
| CTR | Raw | Raw | Raw | Well cooked | Well cooked | Well cooked |
| algility HL | Raw | Well cooked | Well cooked | Well cooked | Well cooked | Well cooked |

C] Fresh Dumpling Sheet

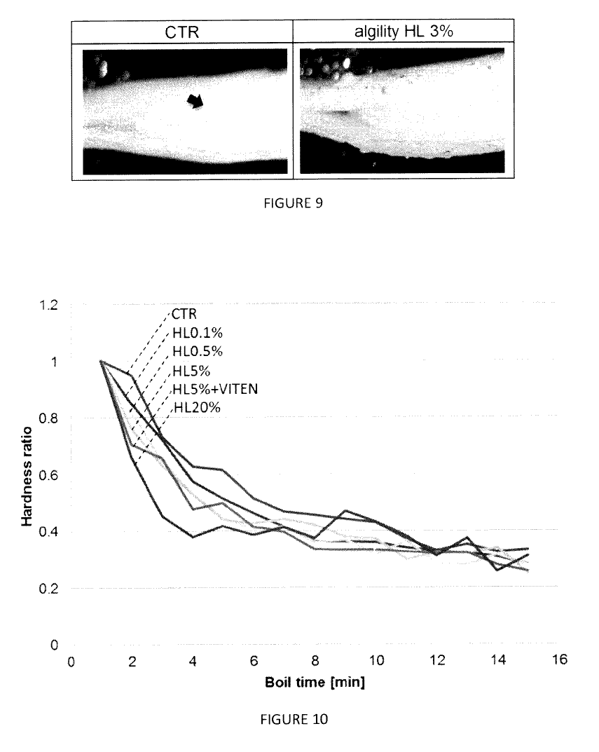

The cooking properties of control dumpling sheet and Algility HL dumpling sheet have been compared using cross section photos thereof. The photos confirm that the cooking speed of the dumpling sheet comprising Algility HL is facter than control one (see FIG. 9 wherein the black arrow pointed out an un-cooked area at the center of the cross section of the control dumpling sheet).

Conclusion

The addition of about 2% to about 3% w/w of Algility HL to fresh and frozen type noodles leads to an important reduction of the cooking time from about 20% to about 50%. It appears that the greatest results are obtained for the fresh type noodles and pasta, which seem more suitable for Algility HL than the frozen type.

### Example 3: Comparison of the Dosages of Microalgal Flour

In order to define the most efficient amount of microalgal flour in noodles suitable for decreasing the cooking time, fresh type Udon noodles have been prepared with various amounts of Algility HL, and their cooking properties have been compared.

The Udon noodles have been prepared according to Example 2, and the various amounts of the ingredients used for manufacturing the Udon noodles are reported in table 22 below.

TABLE 22
Ingredients for Udon noodles with various amounts of Algility HL

| | | CTR | HL0.1% | HL0.5% | HL5% | HL5% VITEN | HL20% |
|---|---|---|---|---|---|---|---|
| Cooking | 1 | 1 | 1 | 1 | 1 | 1 | 1 |
| time[min] | 2 | 0.951 | 0.847 | 0.816 | 0.761 | 0.705 | 0.659 |
| | 3 | 0.731 | 0.721 | 0.647 | 0.631 | 0.657 | 0.453 |
| | 4 | 0.628 | 0.574 | 0.532 | 0.535 | 0.478 | 0.378 |
| | 5 | 0.616 | 0.517 | 0.448 | 0.441 | 0.499 | 0.418 |
| | 6 | 0.517 | 0.464 | 0.408 | 0.426 | 0.416 | 0.386 |
| | 7 | 0.469 | 0.415 | 0.416 | 0.442 | 0.396 | 0.413 |
| | 8 | 0.456 | 0.361 | 0.360 | 0.423 | 0.334 | 0.376 |
| | 9 | 0.442 | 0.361 | 0.369 | 0.379 | 0.333 | 0.470 |
| | 10 | 0.429 | 0.358 | 0.316 | 0.371 | 0.332 | 0.431 |
| | 11 | 0.371 | 0.340 | 0.364 | 0.299 | 0.326 | 0.381 |
| | 12 | 0.330 | 0.328 | 0.288 | 0.324 | 0.320 | 0.311 |
| | 13 | 0.352 | 0.321 | 0.281 | 0.321 | 0.322 | 0.374 |
| | 14 | 0.325 | 0.309 | 0.315 | 0.340 | 0.279 | 0.258 |
| | 15 | 0.331 | 0.282 | 0.280 | 0.250 | 0.258 | 0.312 |

VITEN: wheat gluten

Mixing Properties

HL20% and HL50% show a quite sticky dough texture, and HL50% further shows oil soak out. It appears that the maximal amount to be used is about 20% w/w, higher amounts being prejudicial for the dough texture. Furthermore, amounts less than 5% w/w lead to the best dough texture.

Texture Changes

The texture change of the Udon noodles have been measured with TA, by using “Tooth shape chip” (see Example 1; plunger drop speed is changed by test method: this time 9 mm/min; and plunger shape is change by test method: this time tooth shape).

As well noted in the table 23 below and FIG. 10, the minimal amount of 0.5% w/w is preferred to observe an effective impact on the cooking time. Furthermore, the cooking time of HL5% VITEN is faster than the control noodle. That confirms that the increase of the cooking time is not caused by lack of protein content but by addition of algility HL.

TABLE 23
Hardness of ratio of Udon noodles with various amount of Algility HL

| | | CTR | HL0.1% | HL0.5% | HL5% | HL5% VITEN | HL20% |
|---|---|---|---|---|---|---|---|
| Cooking | 1 | 1 | 1 | 1 | 1 | 1 | 1 |
| time[min] | 2 | 0.950618 | 0.847172 | 0.816353 | 0.760581 | 0.705038 | 0.658664 |
| | 3 | 0.731286 | 0.721466 | 0.646588 | 0.630988 | 0.656762 | 0.453196 |
| | 4 | 0.628316 | 0.574399 | 0.531554 | 0.534518 | 0.477824 | 0.378148 |
| | 5 | 0.615757 | 0.516531 | 0.447864 | 0.441119 | 0.499165 | 0.418136 |
| | 6 | 0.517293 | 0.464141 | 0.408256 | 0.426322 | 0.415703 | 0.38558 |
| | 7 | 0.469012 | 0.415412 | 0.415785 | 0.442362 | 0.395778 | 0.412996 |
| | 8 | 0.455752 | 0.361083 | 0.359916 | 0.422938 | 0.334126 | 0.376049 |
| | 9 | 0.442113 | 0.36061 | 0.369487 | 0.378641 | 0.333426 | 0.470216 |
| | 10 | 0.429064 | 0.358254 | 0.316401 | 0.371331 | 0.331624 | 0.430554 |
| | 11 | 0.37066 | 0.339892 | 0.363509 | 0.299036 | 0.325991 | 0.380631 |
| | 12 | 0.330378 | 0.328152 | 0.287521 | 0.323973 | 0.32035 | 0.31134 |
| | 13 | 0.352316 | 0.320944 | 0.280681 | 0.321196 | 0.321712 | 0.374124 |
| | 14 | 0.324626 | 0.309431 | 0.3155 | 0.339606 | 0.278661 | 0.258255 |
| | 15 | 0.331312 | 0.281722 | 0.280266 | 0.250133 | 0.258136 | 0.311571 |

Conclusions

The presents experiments have confirmed that an effective dosage of Algility HL is preferably comprised between more than 0.1% and 20% w/w. Below 0.1%, no shortening of the cooking time may be observed, while with more than 20% w/w, the dough texture became sticky and oil soak out dough.

### Example 4: Comparison of the Impact of Algility HL or Oil on the Cooking Time

In order to confirm the effect of the addition of Algility HL by themselves on the cooking properties of noodles, the cooking properties of noodles comprising Algility HL or oil have been compared. More precisely, the texture of control noodles, noodles comprising 3% Algility HL and noodles comprising 1.5% Olive oil respectively have been compared (based on the fact that the used Algility HL comprises 50% of lipid).

The water content and weight of the noodles has been measured before the steam process and after the fried process, in order to calculate the increase of the solid content volume.

The instant noodles have been prepared according to Example 1, and the various amounts of the ingredients used for manufacturing the noodles are reported in table 24 below.

TABLE 24
Ingredients

| | | | Oil |
|---|---|---|---|
| Ingredient | CTR | HL 3% | 1.5% |
| Flour (Protein: 11.2%, Ash 0.34%) | 900 | 900 | 900 |
| CLEARAM PG06 | 100 | 100 | 100 |
| Sub total | 1000 | 1000 | 1000 |
| Salt | 15 | 15 | 15 |
| Kansui (K2CO3 60% Na2CO3 40%) | 5 | 5 | 5 |
| Vitamin E | 0.4 | 0.4 | 0.4 |
| Water [Deionized water] | 355 | 355 | 355 |
| algility HL | | 30 | |
| Olive oil | | | 15 |
| Total | 1375.4 | 1405.4 | 1390.4 |

Dipping part

| Ingredients | Volume |
|---|---|
| Salt | 50 |
| Water | 1000 |
| Total | 1050 |

Texture Analysis

The noodles have been cooked in a pan with 500 ml of boiled water for 3 min.

Their texture has been measured by using TA. (Shimadzu EZ-SX)

More particularly, two tests have been implemented:

Test 1:

Condition: Plunger: Knife shape chip
Speed: 3 mm/min Sample size: 1 string

Test 2:

Condition: Plunger: Pull type attachment
Speed: 3 mm/sec Sample size: 4 cm 1 string

Results

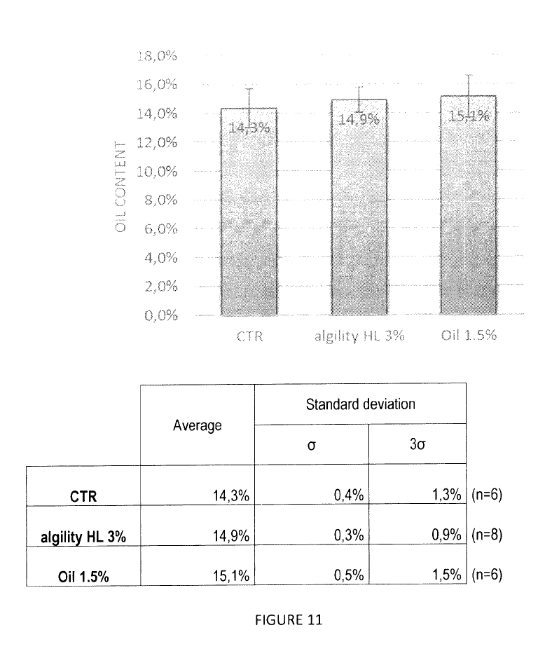

No clear difference between each noodles Oil content has been observed (see FIG. 11), that is to say that neither Algility HL nor Olive oil affect the oil content in this proportion.

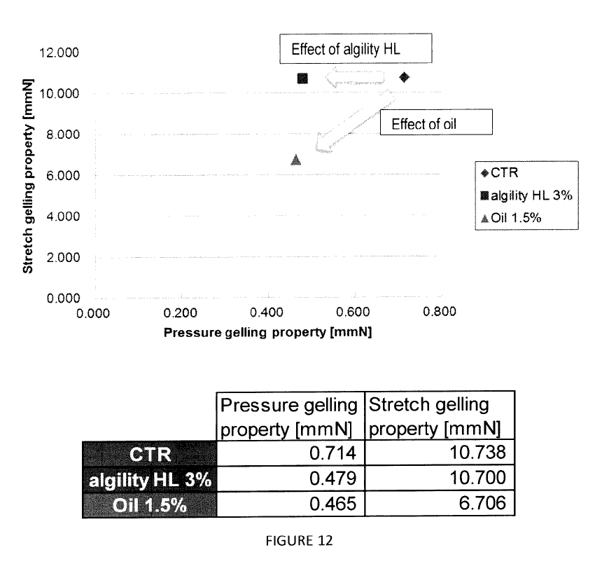

Regarding the pressure gelling property, the noodles which contain Algility HL and Oil show weak/soft texture compared to regular noodles, whereas, the stretch gelling property of the noodles with olive oil shows significantly weak texture compared to regular noodles and Algility HL noodles (see FIG. 12).

Pressure gelling property describes noodle hardness, and more particularly the total power which was needed to cut the noodle string. It is calculated with the below formula and sequence. Hardness [N]*Elasticity[mm]=Pressure gelling property[mmN]

1—Measure the noodle hardness by TA.

2—Extract the TA data of peak point, Hardness[N] and Elasticity[mm].

3—Caluculate them. Hardness*Elasticity=Pressure gelling property

Stretch gelling property describes noodle spring and more particularly the total power which was needed to pull the noodle string. It is calculated with the below formula and sequence.

Load[N]*Stretch[mm]=Stretch gelling property[mmN]

1—Measure the noodle hardness by TA.

2—Extract the TA dataof peak point, Load[N] and Stretch[mm].

3—Caluculate them. Load*Stretch=Stretch gelling property

Consequently, Algility HL decreases only Pressure gelling property, whereas the Olive Oil decreases both Pressure and Stretch gelling property. The Algility HL noodles show a soft but elastic texture compared to Oil noodles that show soft but weak texture.

1. A noodle product comprising for 100 parts of a powder phase, from 0.1 to 20 parts of a microalgal flour comprising at least 50% of lipid by dry weight.

2. The noodle product according to claim 1, wherein the microalgal flour comprises Chlorella.

3. The noodle product according to claim 1, further comprising at least one of from 0 to 10 parts of salt, from 0.2 to 1 part of at least one food additive, and from 2 to 6 parts of egg or egg product.

4. The noodle product according to claim 1, wherein the powder phase comprises at least one powder selected from wheat flour, rice flour, buckwheat flour, wheat semolina, wheat starch, and potato starch.

5. The noodle product according to claim 1, wherein the powder phase comprises at least 90% of lysed cells.

6. The noodle product according to claim 1, wherein 100 parts of the powder phase comprises more than 50 parts of wheat flour.

7. The noodle product according to claim 1, wherein the powder phase solely comprises wheat semolina.

8. A base noodle dough comprising
between 0.05% and 15% w/w of a microalgal flour comprising at least 50% of lipid by dry weight;
between 50% and 80% w/w of at least one powder phase; and
between 20% and 30% w/w of water.

9. The base noodle dough according to claim 8, further comprising:
between 3% and 4% w/w of egg or egg product; and/or
between 1% and 2% w/w of salt; and/or
between 0.15% and 0.30% w/w of food additives selected from alkaline agent, vitamins, gluten supply.

10. Process for preparing noodles, wherein between 0.05% and 15% w/w of a microalgal flour comprising at least 50% of lipid by dry weight are mixed with other dry and liquid ingredients to form a base noodles dough, prior to shaping the noodles.

11. Process for preparing noodles according to claim 10, wherein the noodles are shaped further processed by at least one of steaming, frying, drying and boiling.

12. A method for decreasing noodle cooking time, comprising including as an ingredient for forming a base noodle dough between 0.05 and 15% w/w of microalgal flour comprising at least 50% of lipid by dry weight prior to shaping the noodles.

13. A method of using a microalgal flour comprising at least 50% of lipid by dry weight, comprising adding said microalgal flour to a base noodle dough for decreasing cooking time of noodles formed from said dough.
